(19) United States
(12) Patent Application Publication
(10) Pub. No.: US 2013/0067812 A1
(43) Pub. Date: Mar. 21, 2013

(54) PLANT CONTAINER

(71) Applicant: Jeffery A. Masters, Punta Gorda, FL (US)

(72) Inventor: Jeffery A. Masters, Punta Gorda, FL (US)

(21) Appl. No.: 13/613,166

(22) Filed: Sep. 13, 2012

Related U.S. Application Data
(60) Provisional application No. 61/535,425, filed on Sep. 16, 2011.

(51) Int. Cl. A01G 27/02; A01G 27/06

(52) U.S. Cl. 47/81; 47/79

(57) ABSTRACT

A plant container includes a growing vessel including a floor, a side wall, and a brim. The floor of the growing vessel is adapted to rest on ground below. The side wall is coupled to the floor and arranged to extend upwardly away from the floor to interconnect the floor and the brim. Together, the floor and the side wall define a soil chamber adapted to receive soil and a plant planted in the soil.

### PRIORITY CLAIM

This application claims priority under 35 U.S.C. §119(e) to U.S. Provisional Application Ser. No. 61/535,425, filed Sep. 16, 2011, which is expressly incorporated by reference herein.

### BACKGROUND

The present disclosure relates to a container, and in particular, to a container for growing plants. More particularly, the present disclosure relates to plant container used to provide water to a plant.

### SUMMARY

A plant container in accordance with the present disclosure includes a growing vessel including a floor, a side wall, and a brim. The floor of the growing vessel is adapted to rest on ground below. The side wall is coupled to the floor and arranged to extend upwardly away from the floor to interconnect the floor and the brim. Together, the floor and the side wall define a soil chamber adapted to receive soil and a plant planted in the soil.

In illustrative embodiments, the plant container further includes a water-control system. The water-control system is configured to provide means for storing water by dividing the growing vessel into an upper soil chamber adapted to receive the soil and the plant therein and a lower water-reservoir chamber adapted to receive water therein. The water-control system is further configured to provide means for controlling movement of the water into the upper soil chamber from the lower water-reservoir chamber as need by the plant so that growth of the plant is maximized while maintenance of the plant container is minimized.

In illustrative embodiments, the water-control system includes a vessel divider and a water-uptake conduit. The vessel divider is coupled to the side wall of the growing vessel to define the lower water-reservoir chamber between the vessel divider, the floor, and the side wall. The upper soil chamber is defined by the side wall of the growing vessel and the vessel divider. The water-uptake conduit is coupled to the vessel divider and arranged to extend away from the vessel divider toward the floor and into the lower water-reservoir chamber to cause water to be drawn from the lower water-reservoir chamber into the upper soil chamber by the soil as needed by the plant.

In illustrative embodiments, the water-control system further includes a reservoir-fill conduit coupled to the vessel divider and arranged to extend upwardly away from the vessel divider above the brim of the growing vessel. The reservoir-fill conduit is also arranged to extend downwardly through the vessel divider toward the floor into the lower water-reservoir chamber to cause water poured into the reservoir-fill conduit to move through the soil chamber and into the lower water-reservoir chamber.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a first embodiment of a plant container with portions broken away to reveal that the plant container includes a growing vessel, a vessel divider coupled to a side wall of the growing vessel to cause the growing vessel to be divided into an upper soil chamber that is filled with soil in which a plant has been planted and a lower water-reservoir chamber that has been filled with water to supply the plant, a reservoir-fill conduit extending downwardly through the upper soil chamber and into the lower water-reservoir chamber so that the water-reservoir chamber may be refilled with water (single arrow), and a water-uptake conduit coupled to the vessel divider and arranged to extend downwardly into the water-reservoir chamber so that water (single arrow) is wicked up through soil located in the water-uptake conduit and provided to the plant as needed;

FIG. 2 is a perspective view of the plant container of FIG. 1 with portions broken away to reveal that the vessel divider is formed to include a central water-uptake aperture that is arranged to open into the water-reservoir chamber and through which the water-uptake conduit is arranged to extend through into the water-reservoir chamber and an outer fill-tube aperture that is arranged to open into the water-reservoir chamber and through which a reservoir-fill tube included in the reservoir-fill conduit is arranged to extend through and into the water-reservoir chamber;

FIG. 3 is a section view taken along line 3-3 of FIG. 1 showing that reservoir-fill conduit defines a reservoir-fill passageway that allows water to flow through the soil and into the water-reservoir chamber during refill of the water-reservoir chamber and that the water-uptake conduit defines a water-uptake passageway that is filled with soil that acts as a wick to draw water from the water-uptake passageway into the soil for use by the plant and showing that a fertilizer tablet is positioned to lie in the water-uptake passageway so that as water is drawn up through the water-uptake passageway, fertilizer is drawn from the fertilizer tablet and dispersed into the soil by the water;

FIG. 4 is an exploded assembly view of the plant container of FIGS. 1 and 2 showing that the plant container includes, from top to bottom, a fill spout, a fill tube, a retention collar, a fertilizer tablet, an uptake tube, a vessel divider formed to include a fill-tube aperture and an uptake-tube aperture, and a growing vessel including a brim defining a mouth of the growing vessel, a side wall, and a floor;

FIG. 5 is a perspective view of another embodiment of a plant container with portions broken away to reveal that the plant container includes a growing vessel, a vessel divider coupled to a side wall of the growing vessel to cause the growing vessel to be divided into an upper soil chamber and a lower water-reservoir chamber, a lid coupled to a brim of the growing vessel enclosing the upper soil chamber, a reservoir-fill conduit extending downwardly through the lid, upper soil chamber, and into the lower water-reservoir chamber, and a water-uptake conduit coupled to the vessel divider and arranged to extend downwardly into the water-reservoir chamber;

FIG. 6 is a section view taken along line 6-6 of FIG. 5 showing that reservoir-fill conduit defines a reservoir-fill passageway that allows water to flow through the soil and into the water-reservoir chamber during refill of the water-reservoir chamber and that the water-uptake conduit defines a water-uptake passageway that maybe filled with soil that acts as a wick to draw water from the water-uptake passageway into the soil for use by the plant and suggesting that a fertilizer tablet (in phantom) is positioned to lie in the water-uptake passageway so that as water is drawn up through the water-uptake passageway, fertilizer is drawn from the fertilizer tablet and dispersed into the soil by the water; and

FIG. 7 is an exploded assembly view of the plant container of FIGS. 5 and 6 showing that the plant container includes, from top to bottom, a fill spout, a fill tube, a growing-vessel lid formed to include a smaller diameter fill-conduit aperture and a larger diameter plant-growth aperture, a vessel divider formed to include a smaller diameter fill-tube aperture and a larger diameter water-uptake aperture, an uptake spout, a fertilizer tablet, an uptake tube, and a growing vessel including a brim defining a mouth of the growing vessel, a side wall, and a floor.

### DETAILED DESCRIPTION

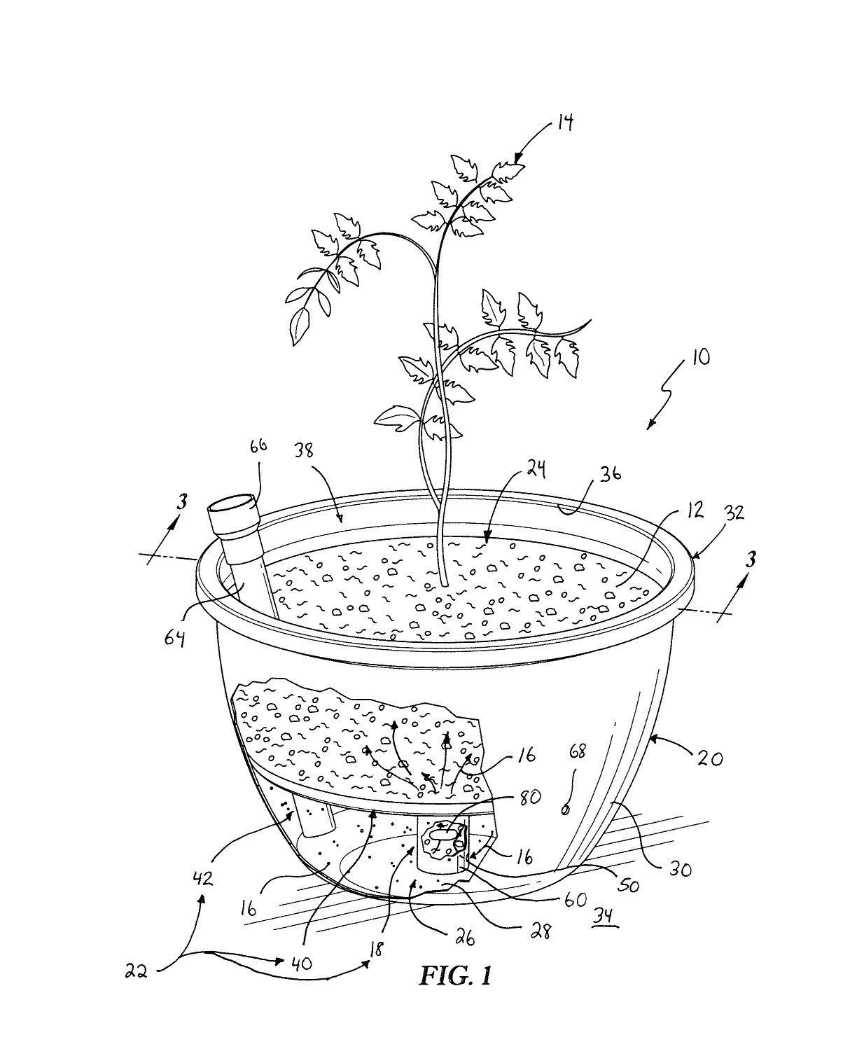

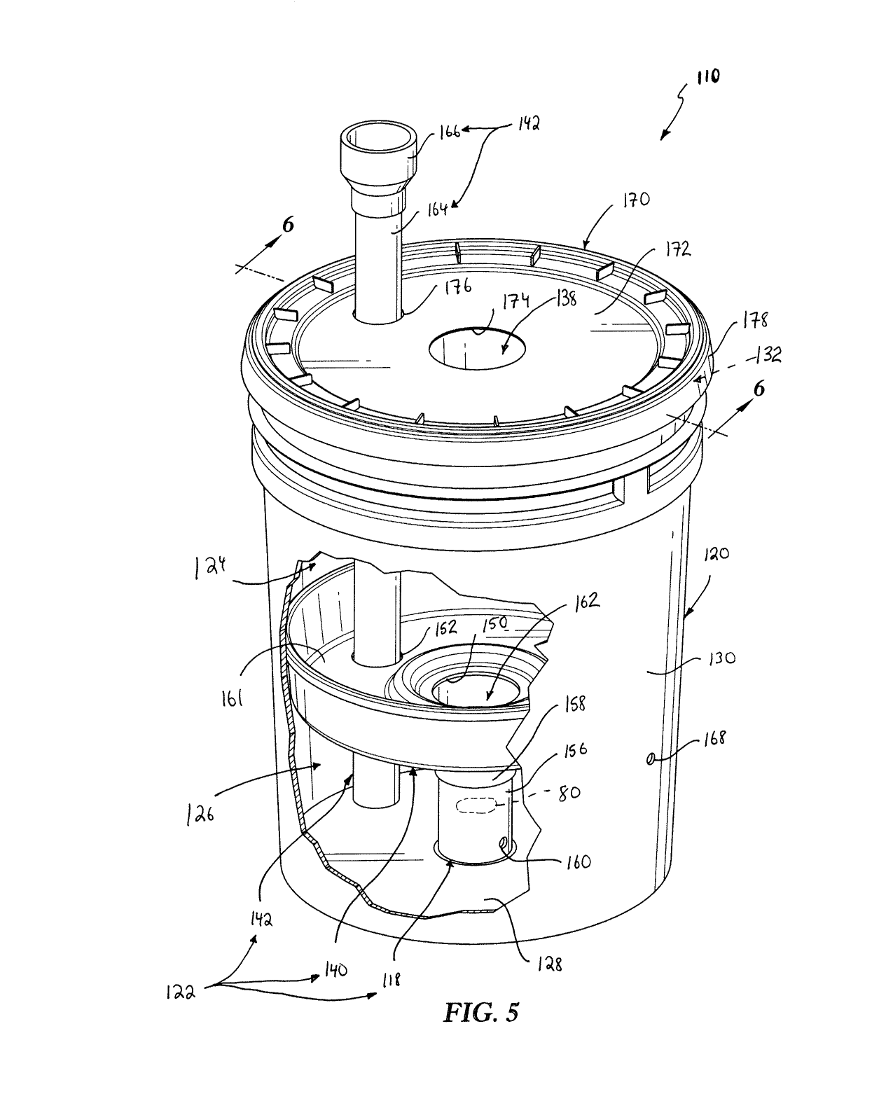

A first embodiment of a plant container 10 in accordance with the present disclosure is shown in FIGS. 1-4. Another embodiment of a plant container 110 in accordance with the present disclosure is shown in FIGS. 5-7. Plant containers 10, 110 are formed to include an upper soil chamber filled with soil 12 in which a plant 14 is planted and a lower water-reservoir chamber that has been filled with water 16. A water-uptake conduit 18 is arranged to interconnect the upper soil chamber and the lower water-reservoir chamber so that water 16 (single solid arrow) is wicked up through soil 12 located in water-uptake conduit 18 and provided to plant 14 as needed by plant 14.

Plant container 10 includes a growing vessel 20 and a water-control system 22 as shown in FIGS. 1-4. Water-control system 22 is configured to provide means for storing water by dividing growing vessel 20 into an upper soil chamber 24 adapted to receive soil 12 and plant 14 therein and a lower water-reservoir chamber 26 adapted to receive water 16 therein and for controlling movement of water 16 into upper soil chamber 24 from lower water-reservoir chamber 26 as need by plant 14 so that growth of plant 14 is maximized while maintenance of plant container 10 is minimized.

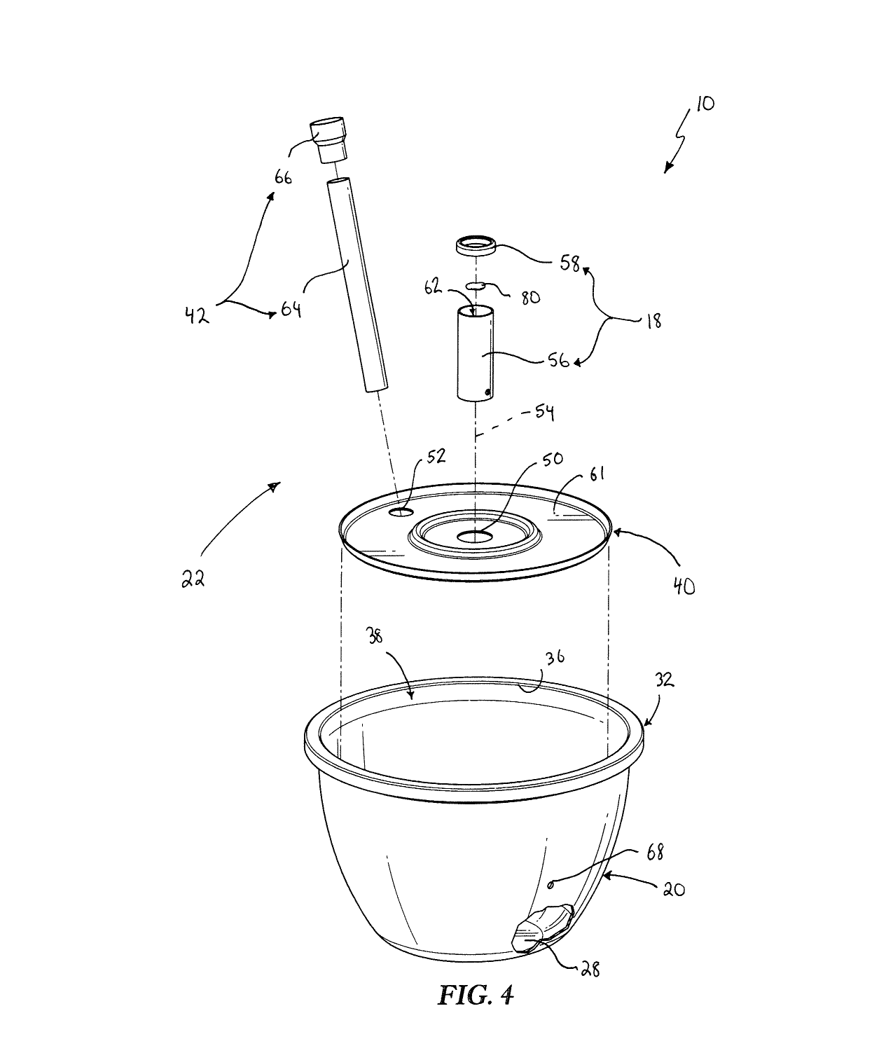

Growing vessel 20 includes a floor 28, a side wall 30, and a brim 32 as shown, for example, in FIG. 4. Floor 28 is adapted to rest on and be supported by ground 34 as shown in FIG. 1. Side wall 30 is appended to floor 28 and is arranged to extend upwardly away from floor 28. Brim 32 is appended to side wall 30 and configured to define a mouth 36 arranged to open into an interior region 38 of growing vessel 20. Interior region 38 is defined by side wall 30 and floor 28.

Water-control system 22 illustratively includes a vessel divider 40, a water-uptake conduit 18, and a reservoir-fill conduit 42 as shown in FIG. 4. Vessel divider 40 is coupled to a side wall 30 and arranged to divide interior region 38 into upper soil chamber 24 and lower water-reservoir chamber 26 as shown in FIGS. 1-3. Water-uptake conduit 18 is appended to vessel divider 40 and arranged to extend downwardly into lower water-reservoir chamber 26. Reservoir-fill conduit 42 is appended to vessel divider 40 and is arranged to extend upwardly above brim 32 to extend downwardly into lower water-reservoir chamber 26.

During use of plant container 10, soil 12 is placed in upper soil chamber 24 and plant 14 is planted in soil 12. At the same time, soil 12 is also placed in water-uptake conduit 18. Water 16 is then poured through a reservoir-fill passageway 82 formed in reservoir-fill conduit 42 that extends through soil 12, past vessel divider 40, and into lower water-reservoir chamber 26 filling lower water-reservoir chamber 26 with water 16 for use by plant 14. Soil 12 in water-uptake conduit 18 is in communication with water 16 in lower water-reservoir chamber 26. Soil 12 in water-uptake conduit 18 acts like a wick pulling water 16 into upper soil chamber 24 as needed by plant 14.

Vessel divider 40 is formed to include a water-uptake aperture 50 and a fill-tube aperture 52 as shown in FIG. 4. Water-uptake aperture 50 is arranged to open into lower water-reservoir chamber 26 and receive water-uptake conduit 18 therein. Fill-tube aperture 52 is arranged to open into lower water-reservoir chamber 26 and receive reservoir-fill conduit 42 therein. As shown in FIG. 4, water-uptake aperture 50 is centered along a central axis 54 of plant container 10. Fill-tube aperture 52 is spaced apart from water-uptake aperture 50 and positioned to lie between water-uptake aperture 50 and side wall 30 of growing vessel 20.

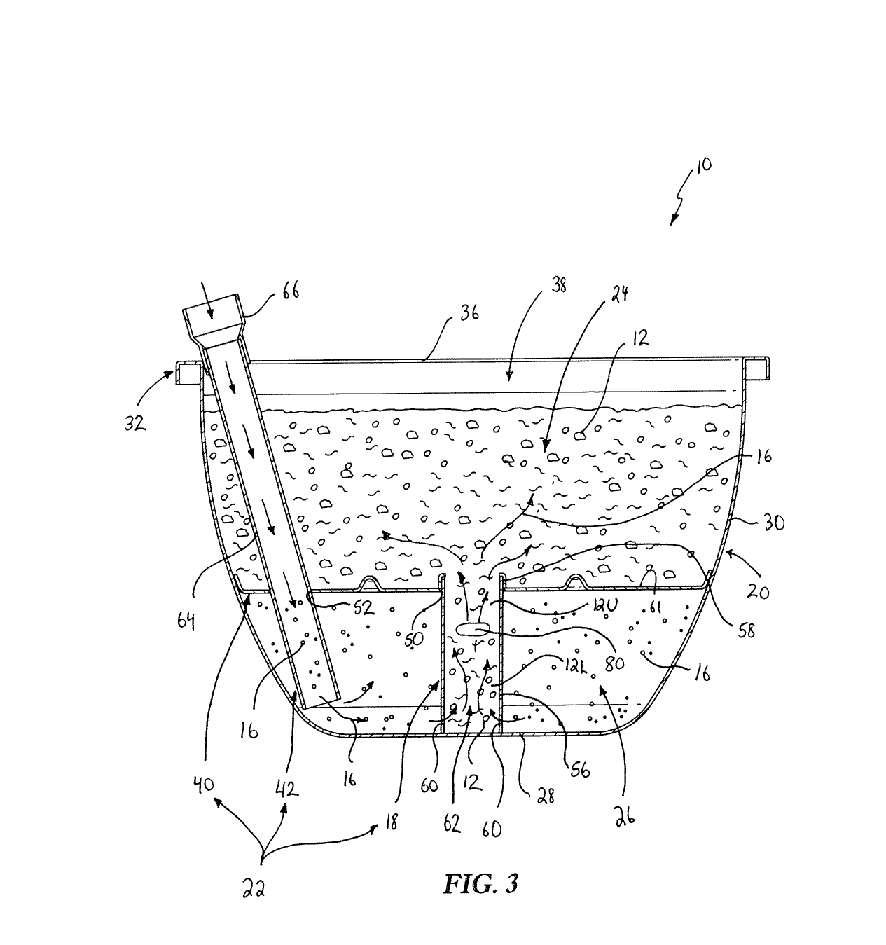

Water-uptake conduit 18 includes, for example, a water-uptake tube 56 and a tube-retention collar 58 as shown in FIG. 4. Water-uptake tube 56 is arranged to extend from an upper side 61 of vessel divider 40 through water-uptake aperture 50 and into lower water-reservoir chamber 26 as shown in FIG. 3. Tube-retention collar 58 is coupled to an upper end of water-uptake tube 56 to retain water-uptake tube 56 in place relative to vessel divider 40. A series of spaced-apart water-uptake holes 60 are formed in water-uptake tube 56 and are arranged to open into a water-uptake passageway 62 formed in water-uptake tube 56 to cause water 16 to flow into water-uptake passageway 62 and contact soil 12 also positioned in water-uptake passageway 62.

Reservoir-fill conduit 42 includes, for example, a reservoir-fill tube 64 and a fill spout 66 as shown in FIG. 4. Reservoir-fill tube 64 is arranged to extend from upper side 60 of vessel divider 40 through fill-tube aperture 52 into lower water-reservoir chamber 26 and from upper side 60 of vessel divider 40 toward brim 32 as shown in FIG. 3. A lower end of reservoir-fill tube 64 is arranged to lie in lower water-reservoir chamber 26 and an opposite upper end of reservoir-fill tube 64 is coupled to fill spout 66. Fill spout 66 is configure to have a larger diameter that is configured to receive water therein and a smaller diameter configured to mate with reservoir-fill tube 64 as shown in FIG. 4.

As shown in FIG. 4, water-overflow aperture 68 is formed in side wall 30. Water-overflow aperture 68 is arranged to open into lower water-reservoir chamber 26 and allow water 16 to flow out of lower water-reservoir chamber 26 through water-overflow aperture 68 when lower water-reservoir chamber 26 has been overfilled with water 16.

Maintenance of plant container 10 may be further minimized by including a fertilizer tablet 80 in plant container 10. Fertilizer tablet 80 is configured to provide fertilizer means for a fertilizer to water 16 to cause the fertilizer to be dispersed into soil 12 in upper soil chamber 24 in response to water 16 moving from lower water-reservoir chamber 26 through water-uptake passageway 62 and into upper soil chamber 24 so that maintenance of the plant container is minimized. As an example, fertilizer tablet 80 is located in water-uptake passageway 62 so that as water 16 is drawn up through water-uptake passageway 62, fertilizer is drawn from fertilizer tablet 80 and dispersed into soil 12 by the water 16 as shown in FIGS. 1-4. As an example, fertilizer tablet 80 is positioned to lie between a lower soil layer 12L in water-uptake passageway 62 and an upper soil layer 12U located in water-uptake passageway as shown in FIG. 3. As another example, fertilizer tablet 80 may be positioned between upper soil layer 12U and upper soil chamber 24.

Plant container 110 includes a growing vessel 120, a lid 170 and a water-control system 122 as shown in FIGS. 1-4. Water-control system 122 is configured to provide means for storing water by dividing growing vessel 120 into an upper soil chamber 124 adapted to receive soil 12 and plant 14 therein and a lower water-reservoir chamber 126 adapted to receive water 16 therein and for controlling movement of water 16 into upper soil chamber 124 from lower water-reservoir chamber 126 as need by plant 14 so that growth of plant 14 is maximized while maintenance of plant container 110 is minimized.

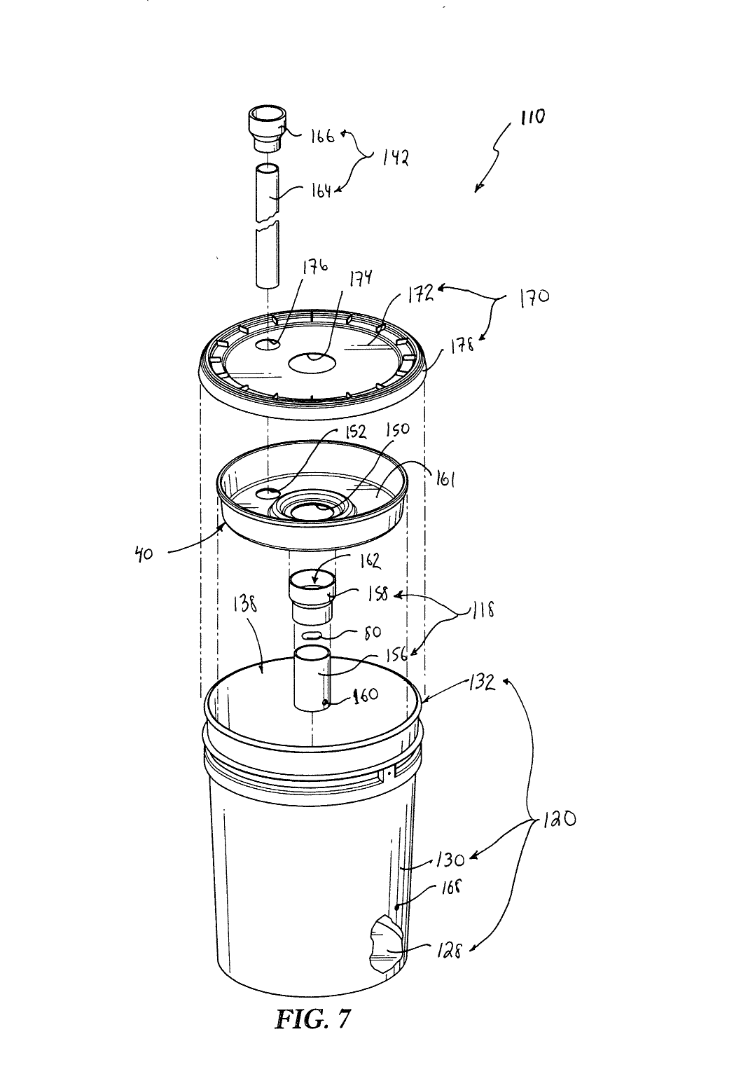

Growing vessel 120 includes a floor 128, a side wall 130, and a brim 32 as shown, for example, in FIG. 7. Floor 128 is adapted to rest on and be supported by ground 34. Side wall 130 is appended to floor 128 and is arranged to extend upwardly away from floor 128. Brim 132 is appended to side wall 130 and configured to define a mouth 136 arranged to open into an interior region 138 of growing vessel 120. Lid 170 is coupled to brim 132 to enclose and define interior region 138 between lid 170, side wall 130, and floor 128.

Lid 170 includes a closure 172 and a rim 178 as shown in FIG. 7. Rim 178 is appended to closure 172 and arranged to mate with brim 132 to close mouth 136. As an example, rim 178 and brim 132 may cooperate to form a snap-fit connection. As another example, rim 178 and brim 132 may be coupled together be a threaded connection. Upper soil chamber 124 is defined by closure 172, side wall 130 and vessel divider 140.

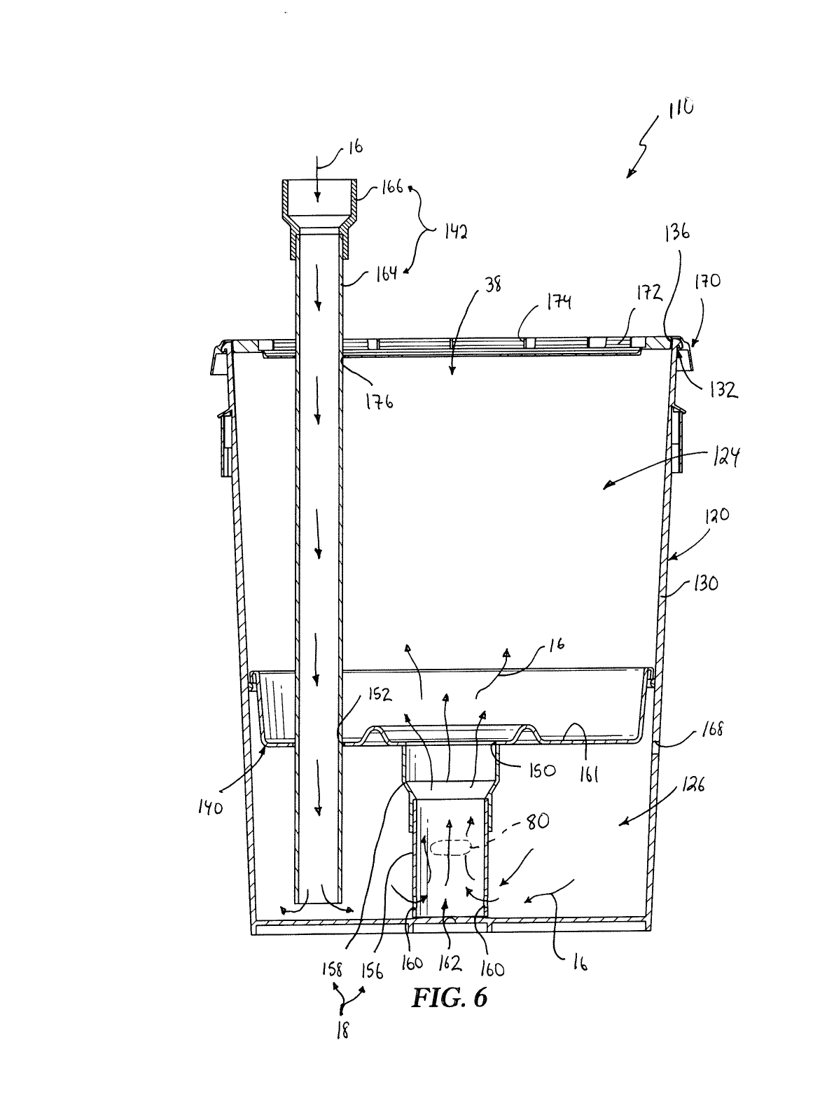

Water-control system 122 illustratively includes a vessel divider 140, a water-uptake conduit 118, and a reservoir-fill conduit 142 as shown in FIG. 7. Vessel divider 140 is coupled to a side wall 130 and arranged to divide interior region 138 into upper soil chamber 124 and lower water-reservoir chamber 126 as shown in FIGS. 5 and 6. Water-uptake conduit 118 is appended to vessel divider 140 and arranged to extend downwardly into lower water-reservoir chamber 126. Reservoir-fill conduit 142 is appended to vessel divider 140 and is arranged to extend upwardly through lid 170 to extend downwardly into lower water-reservoir chamber 126.

During use of plant container 110, soil 12 is placed in upper soil chamber 124 and plant 14 is planted in soil 12. At the same time, soil 12 is also placed in water-uptake conduit 118. Water 16 is then poured into a reservoir-fill passageway 182 formed in reservoir-fill conduit 142 that extends through soil 12, past vessel divider 140, and into lower water-reservoir chamber 126 filling lower water-reservoir chamber 126 with water 16 for use by plant 14. Soil 12 in water-uptake conduit 118 is in communication with water 16 in lower water-reservoir chamber 126 and acts like a wick pulling water 16 into upper soil chamber 124 as needed by plant 14.

Vessel divider 140 is formed to include a water-uptake aperture 150 and a fill-tube aperture 152 as shown in FIG. 7. Water-uptake aperture 150 is arranged to open into lower water-reservoir chamber 126 and receive water-uptake conduit 118 therein. Fill-tube aperture 129 is arranged to open into lower water-reservoir chamber 126 and receive reservoir-fill conduit 142 therein. As shown in FIG. 7, water-uptake aperture 150 is centered along a central axis 154 of plant container 110. Fill-tube aperture 129 is spaced apart from water-uptake aperture 150 and positioned to lie between water-uptake aperture 150 and side wall 130 of growing vessel 120.

Closure 172 is formed to include a plant aperture 174 and a fill-conduit aperture 176 as shown in FIG. 7. Plant aperture 174 is arranged to open into upper soil chamber 124 and is configured to allow plant 14 to extend out of upper soil chamber 124 through plant aperture 174. Fill-conduit aperture 176 is arranged to open in upper soil chamber 124 and is configured to receive reservoir-fill conduit 142 therein. Plant aperture 174 is centered along central axis 154 and aligned with water-uptake aperture 150. Fill-conduit aperture 176 is spaced-apart from plant aperture 174 and aligned with fill-tube aperture 129 as shown, for example, in FIG. 7.

Water-uptake conduit 118 includes, for example, a water-uptake tube 156 and a water-uptake spout 158 as shown in FIG. 7. Water-uptake spout 158 is coupled to a lower side 161 of vessel divider 140 and is arranged to extend from vessel divider 140 downwardly into lower water-reservoir chamber 126. Water uptake tube 144 is coupled to water-uptake spout 158 and is arranged to extend from water-uptake spout 158 toward floor 128 as shown in FIG. 6. A series of spaced-apart water-uptake holes 160 are formed in water-uptake tube 156 and are arranged to open into a water-uptake passageway 162 defined by water-uptake tube 156 to cause water 16 to flow into water-uptake passageway 162 and contact soil 12 positioned in water-uptake passageway 162.

Reservoir-fill conduit 142 includes, for example, a reservoir-fill tube 164 and a fill spout 166 as shown in FIG. 7. Reservoir-fill tube 164 is arranged to extend from upper side 160 of vessel divider 140 through fill-tube aperture 152 into lower water-reservoir chamber 126 and from upper side 161 of vessel divider 140 through fill-conduit aperture 176 formed in lid 170 as shown in FIG. 5. A lower end of reservoir-fill tube 164 is arranged to lie in lower water-reservoir chamber 126 and an opposite upper end of reservoir-fill tube 164 is coupled to fill spout 166. Fill spout 166 is configure to have a larger diameter that is configured to receive water therein and a smaller diameter configured to mate with reservoir-fill tube 164 as shown in FIG. 7.

As shown in FIG. 7, water-overflow aperture 168 is formed in side wall 130. Water-overflow aperture 168 is arranged to open into lower water-reservoir chamber 126. Water-overflow aperture 168 is configured to allow water 16 to flow out of lower water-reservoir chamber 126 through water-overflow aperture 168 when lower water-reservoir chamber 126 has been overfilled with water 16.

Maintenance of plant container 110 may be further minimized by locating a fertilizer tablet 80 in water-uptake passageway 162 as shown in FIGS. 5-7. Fertilizer tablet 80 is positioned to lie in water-uptake passageway 162 so that as water 16 is drawn up through water-uptake passageway 162, fertilizer is drawn from fertilizer tablet 80 and dispersed into soil 12 by the water 16. As an example, fertilizer tablet 80 is positioned to lie between a lower soil layer in water-uptake passageway 162 and an upper soil layer located in water-uptake passageway. As another example, fertilizer tablet 80 may be positioned between upper soil layer and upper soil chamber 124.

A plant container 10, 110 in accordance with the present disclosure is shown in FIGS. 1-7. The plant container 10, 110 may include a growing vessel 20, 120, a side wall 30, 130, a brim 32, 132, and a water-control system 22, 122. The growing vessel 20, 120 may include a floor 28, 128 adapted to rest on ground below the floor 28, 128. The side wall 30, 130 may be coupled to the floor 28, 128 to extend upwardly away from the floor 28, 128 and cooperating with the floor 28, 128 to define a soil chamber 24, 124 therebetween. The brim 32, 132 may be coupled to the side wall 30, 130 to locate the side wall 30, 130 between the floor 28, 128 and the brim 32, 132. The water-control system 22, 122 may be configured to provide means for storing water 16 by dividing the growing vessel 20, 120 into an upper soil chamber 24, 124 and a lower water-reservoir chamber 26, 126. The upper soil chamber 24, 124 may be adapted to receive soil 12 and a plant 14. The lower water-reservoir chamber 26, 126 may be adapted to receive water 16. The lower water-reservoir chamber 26, 126 may also be adapted for controlling movement of the water 16 into the upper soil chamber 24, 124 from the lower water-reservoir chamber 26, 126 as needed by the plant 14 so that growth of the plant 14 is maximized while maintenance of the plant container 10, 110 is minimized.

In another embodiment, the water-control system 22, 122 may include a vessel divider 40, 140 and a water-uptake conduit 18, 118. The vessel divider 40, 140 may be coupled to the side wall 30, 130 of the growing vessel 20, 120 in spaced-apart relation above the floor 28, 128. The water-uptake conduit 18, 118 may be coupled to the vessel divider 40, 140 to extend away from the vessel divider 40, 140 toward the floor 28, 128 into the lower water-reservoir chamber 26, 126 to cause the water 16 to be drawn from the lower water-reservoir chamber 26, 126 into the upper soil chamber 24, 124 by the soil 12 as needed by the plant 14.

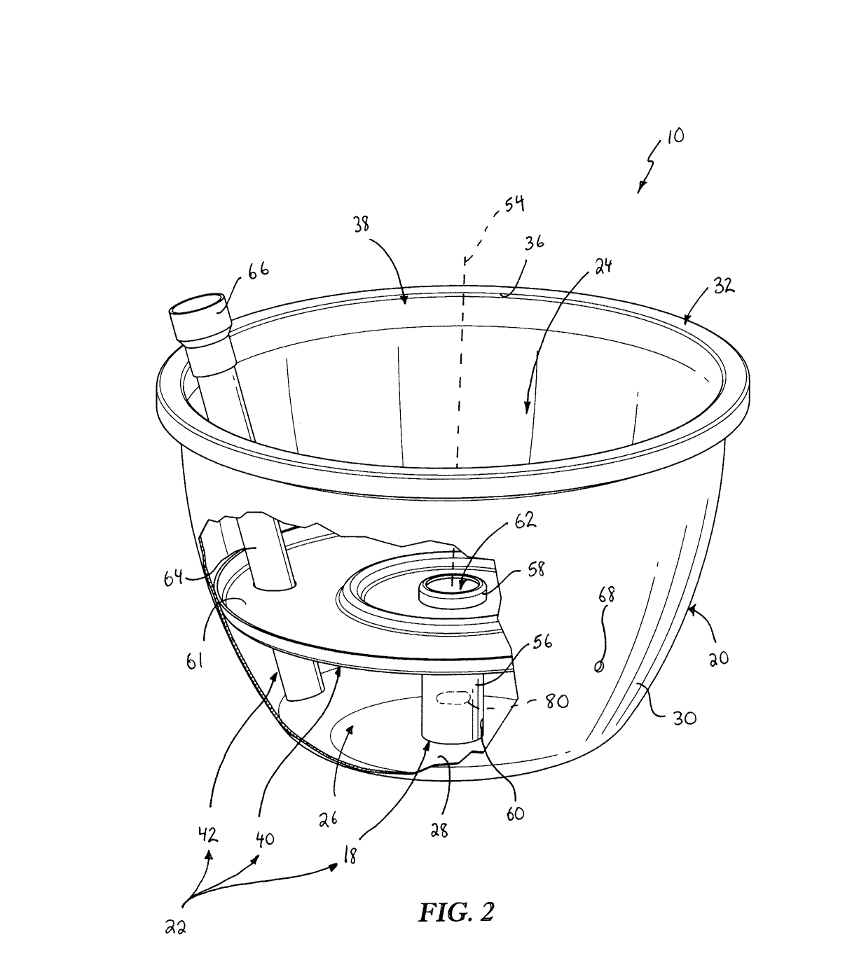

Referring now to FIGS. 2 and 5, in another illustrated embodiment, the lower water-reservoir chamber 26, 126 may be defined by the vessel divider 40, 140, the floor 28, 128, and the side wall 30, 130. In another embodiment, the upper soil chamber 24, 124 may be defined by the side wall 30, 130 and the vessel divider 40, 140.

In yet another illustrated embodiment, the water-control system 22, 122 may be configured to provide means for moving water 16 through the upper soil chamber 24, 124 without contacting the soil 12 and through the vessel divider 40, 140 to cause the lower water-reservoir chamber 26, 126 to be filled with the water 16 as shown in FIG. 3. In another embodiment, the water-control system 22, 122 may include a reservoir-fill conduit 42, 142 coupled to the vessel divider 40, 140 to extend upwardly away from the vessel divider 40, 140 through the soil 12 toward the brim 32, 132 and to extend downwardly toward the floor 28, 128 into the lower water-reservoir chamber 26, 126.

In another embodiment, the vessel divider 40, 140 may be formed to include a water-uptake aperture 50, 150 as shown in FIGS. 4 and 7. The water-uptake conduit 18, 118 may be arranged to extend through the water-uptake aperture 50, 150.

In another embodiment, the water-control system 22, 122 may be configured to provide means for moving water 16 through the upper soil chamber 24, 124 without contacting the soil 12 to cause the lower water-reservoir chamber 26, 126 to be filled with the water 16. In yet another embodiment, the water-control system 22, 122 may include a vessel divider 40, 140 and a reservoir-fill conduit 42, 142. The water-control system 22, 122 may be coupled to the side wall 30, 130 of the growing vessel 20, 120 in spaced-apart relation above the floor 28, 128. The reservoir-fill conduit 42, 142 may be coupled to the vessel divider 40, 140 to extend upwardly away from the vessel divider 40, 140 through the soil 12 toward the brim 32, 132 and to extend downwardly toward the floor 28, 128 into the lower water-reservoir chamber 26, 126.

In another embodiment, the reservoir-fill conduit 42, 142 may include a reservoir-fill tube 64, 164 coupled to the vessel divider 40, 140 to extend upwardly away from the vessel divider 40, 140 through the soil 12 and to extend downwardly toward the floor 28, 128 into the lower water-reservoir chamber 26, 126. In yet another embodiment, the vessel divider 40, 140 may be formed to include a fill-tube aperture 52, 152 and the reservoir-fill conduit 42, 142 may be arranged to extend through the fill-tube aperture 52, 152.

Referring now to FIG. 5, in an illustrated embodiment, the plant container 110 may include a lid 170. The lid 170 may be coupled to the brim 132 to close a mouth 136 defined by the brim 132 that opens into the upper soil chamber 124.

In another embodiment, the water-control system 22, 122 may include a vessel divider 40, 140, a water-uptake conduit 18, 118, and a reservoir-fill conduit 42, 142. The vessel divider 40, 140 may be coupled to the side wall 30, 130 of the growing vessel 20, 120 in spaced-apart relation above the floor 28, 128. The water-uptake conduit 18, 118 may be coupled to the vessel divider 40, 140 to extend away from the vessel divider 40, 140 toward the floor 28, 128 into the lower water-reservoir chamber 26, 126. The reservoir-fill conduit 42, 142 may be coupled to the vessel divider 40, 140 to extend upwardly away from the vessel divider 40, 140 through the upper soil chamber 24, 124 toward the brim 32, 132 and to extend downwardly toward the floor 28, 128 into the lower water-reservoir chamber 26, 126.

In another embodiment, the lid 170 of the plant container 110 may be formed to include a fill-conduit aperture 176. The reservoir-fill conduit 142 may be arranged to extend out of the upper soil chamber 124 through the fill-conduit aperture 176.

In yet another embodiment, the lid 170 may be formed to include a plant aperture 174. The plant aperture 174 may be arranged to open into the upper soil chamber 124 and may be positioned to lie in spaced-apart relation to the fill-conduit aperture 176.

Referring now to FIGS. 6-7, in another illustrated embodiment, the water-uptake conduit 118 may include a water-uptake spout 158 and a water-uptake tube 156. The water-uptake spout 158 may be coupled to the vessel divider 140 and may be arranged to extend toward the floor 128. The water-uptake tube 156 may be coupled to the water-uptake spout 158 to locate the water-uptake spout 158 between the water-uptake tube 156 and the vessel divider 140.

As shown in FIGS. 1-7, in another embodiment, the water-uptake tube 56, 156 may be formed to include a water-uptake hole 60, 160 that opens into a water-uptake passageway 62, 162 formed in the water-uptake conduit 18, 118. The water-uptake passageway 62, 162 may communicate the water 16 from the lower water-reservoir chamber 26, 126 to the upper soil chamber 24, 124.

In another embodiment, the soil 12 may be located in the upper soil chamber 24, 124. The water-uptake passageway 62, 162 and the soil 12 may wick water 16 from the lower water-reservoir chamber 26, 126 into the upper soil chamber 24, 124.

In another embodiment, the plant container 10, 110 may include fertilizer means 80 for providing a fertilizer to the water 16 to cause the fertilizer to be dispersed into the soil 12 in the upper soil chamber 24, 124 in response to the water 16 moving from the lower water-reservoir chamber 26, 126 through the water-uptake passageway 62, 162 and into the upper soil chamber 24, 124 so that maintenance of the plant container 10, 110 is minimized. In yet another embodiment, the fertilizer means 80 may include a fertilizer tablet 80 positioned to lie in the water-uptake passageway 62, 162 between the floor 28, 128 and the vessel divider 40, 140.

1. A plant container comprises
a growing vessel including a floor adapted to rest on ground below the floor, a side wall coupled to the floor to extend upwardly away from the floor and cooperating with the floor to define a soil chamber therebetween, and a brim coupled to the side wall to locate the side wall between the floor and the brim and
a water-control system configured to provide means for storing water by dividing the growing vessel into an upper soil chamber adapted to receive soil and a plant therein and a lower water-reservoir chamber adapted to receive water therein and for controlling movement of the water into the upper soil chamber from the lower water-reservoir chamber as needed by the plant so that growth of the plant is maximized while maintenance of the plant container is minimized.

2. The plant container of claim 1, wherein the water-control system includes a vessel divider coupled to the side wall of the growing vessel in spaced-apart relation above the floor and a water-uptake conduit coupled to the vessel divider to extend away from the vessel divider toward the floor into the lower water-reservoir chamber to cause the water to be drawn from the lower water-reservoir chamber into the upper soil chamber by the soil as needed by the plant.

3. The plant container of claim 2, wherein the lower water-reservoir chamber is defined by the vessel divider, the floor, and the side wall.

4. The plant container of claim 3, wherein the upper soil chamber is defined by the side wall and the vessel divider.

5. The plant container of claim 2, wherein the water-control system is further configured to provide means for moving water through the upper soil chamber without contacting the soil and through the vessel divider to cause the lower water-reservoir chamber to be filled with the water.

6. The plant container of claim 5, wherein the water-control system further includes a reservoir-fill conduit coupled to the vessel divider to extend upwardly away from the vessel divider through the soil toward the brim and to extend downwardly toward the floor into the lower water-reservoir chamber.

7. The plant container of claim 6, wherein the vessel divider is formed to include a water-uptake aperture and the water-uptake conduit is arranged to extend through the water-uptake aperture.

8. The plant container of claim 1, wherein the water-control system is further configured to provide means for moving water through the upper soil chamber without contacting the soil to cause the lower water-reservoir chamber to be filled with the water.

9. The plant container of claim 8, wherein the water-control system includes a vessel divider coupled to the side wall of the growing vessel in spaced-apart relation above the floor and a reservoir-fill conduit coupled to the vessel divider to extend upwardly away from the vessel divider through the soil toward the brim and to extend downwardly toward the floor into the lower water-reservoir chamber.

10. The plant container of claim 9, wherein the reservoir-fill conduit includes a reservoir-fill tube coupled to the vessel divider to extend upwardly away from the vessel divider through the soil and to extend downwardly toward the floor into the lower water-reservoir chamber.

11. The plant container of claim 10, wherein the vessel divider is formed to include a fill-tube aperture and the reservoir-fill conduit is arranged to extend through the fill-tube aperture.

12. The plant container of claim 1, further comprising a lid coupled to the brim to close a mouth defined by the brim that opens into the upper soil chamber.

13. The plant container of claim 12, wherein the water-control system includes a vessel divider coupled to the side wall of the growing vessel in spaced-apart relation above the floor, a water-uptake conduit coupled to the vessel divider to extend away from the vessel divider toward the floor into the lower water-reservoir chamber, and a reservoir-fill conduit coupled to the vessel divider to extend upwardly away from the vessel divider through the upper soil chamber toward the brim and to extend downwardly toward the floor into the lower water-reservoir chamber.

14. The plant container of claim 13, wherein the lid is formed to include a fill-conduit aperture and the reservoir-fill conduit is arranged to extend out of the upper soil chamber through the fill-conduit aperture.

15. The plant container of claim 14, wherein the lid is further formed to include a plant aperture arranged to open into the upper soil chamber and positioned to lie in spaced-apart relation to the fill-conduit aperture.

16. The plant container of claim 13, wherein the water-uptake conduit includes a water-uptake spout coupled to the vessel divider and arranged to extend toward the floor and a water-uptake tube coupled to the water-uptake spout to locate the water-uptake spout between the water-uptake tube and the vessel divider.

17. The plant container of claim 16, wherein the water-uptake tube is formed to include a water-uptake hole that opens into a water-uptake passageway formed in the water-uptake conduit that communicates the water from the lower water-reservoir chamber to the upper soil chamber.

18. The plant container of claim 17, wherein the soil is located in the upper soil chamber and the water-uptake passageway and the soil wicks water from the lower water-reservoir chamber into the upper soil chamber.

19. The plant container of claim 18, further comprising fertilizer means for providing a fertilizer to the water to cause the fertilizer to be dispersed into the soil in the upper soil chamber in response to the water moving from the lower water-reservoir chamber through the water-uptake passageway and into the upper soil chamber so that maintenance of the plant container is minimized.

20. The plant container of claim 18, wherein the fertilizer means includes a fertilizer tablet positioned to lie in the water-uptake passageway between the floor and the vessel divider.
